(19) United States
(12) Patent Application Publication
(10) Pub. No.: US 2022/0249985 A1
(43) Pub. Date: Aug. 11, 2022

(54) Container Lid With A Removable Filter And Barrier

(71) Applicant: Joseph John Losito, Olathe, KS (US)

(72) Inventor: Joseph John Losito, Olathe, KS (US)

(73) Assignee: Joseph Losito, Olathe, KS (US)

(21) Appl. No.: 17/248,807

(22) Filed: Feb. 9, 2021

(51) Int. Cl. B01D 29/01; A47G 19/22; B01D 29/96; B01F 3/12

(52) U.S. Cl. CPC B01D 29/01; A47G 19/2272; B01F 2215/0022; B01F 3/12; B01D 29/96

(57) ABSTRACT

A container lid for mixing different substances. The filter acts as both a mixing apparatus and a impediment to stop unmixed substances and solid items from passing through.

This non-provisional application claims the benefit of provisional application No. 62/972,531 filed Feb. 10, 2020.

### BACKGROUND

The present invention relates to a drinking container lid that can blend certain powders and liquids together, while not letting unmixed clumps or other large items to pass through, such as ice. More particularly, a lid that includes a removable filter that can act as both an mixing apparatus and a barrier to keep large objects from passing through. The lid and agitator can be fully integrated into a single unit so as to keep the combined unit compact and the filter stationary during mixing. Within the scope of this invention the filter can engage the sidewall of the lid using clips or in many other forms, including a snap fit, compression, threaded, or similar mechanical attachment method.

When mixing powdered supplements such as protein powder, a user may find difficulty in mixing the protein fully, prohibiting any clumped unmixed powder from being consumed, and cleaning the mixing filter and barrier. To solve these issues, the need for a lid that can mix substances, stop clumps from reaching the consumer, and also be easily removable for cleaning arises.

### SUMMARY

It is an object of the present invention to provide an assembly that is useful for mixing together substances. It is a further object for such an assembly to prohibit any substance that is not thoroughly mixed or solid in nature to not pass through. Accordingly, it is another object of the invention that the filter span the complete opening of the lid so as that any unmixed substance or solid items cannot find their way through.

Finally, it is another object of the invention to be easily disassembled for ease of cleaning and maintenance.

### BRIEF DESCRIPTION OF THE DRAWINGS

FIG. 1: An isometric view of the invention, showing the lid and filter apparatus.

FIG. 2: A profile view of the invention, showing the filter in an installed and locked position

FIG. 3: A profile view showing the lid (301) with cap (303) closed and filter (302) separated from the lid (301).

FIG. 4: A bottom view showing the filter fully spanning the opening of the lid.

FIG. 5: A profile view of the filter piece. The connecting clips (501) and filter (502) are visible.

FIG. 6: A profile view of the filter piece. The pull tab is visible (601).

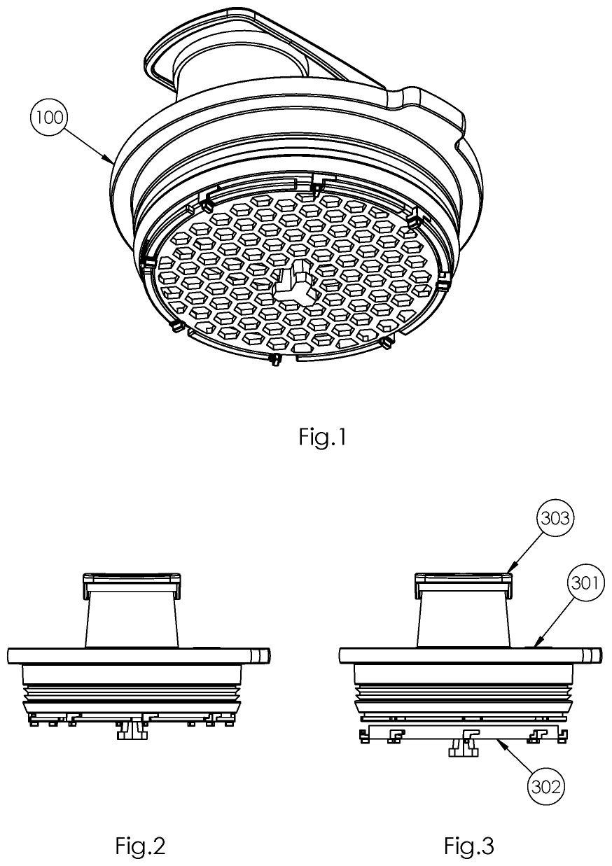

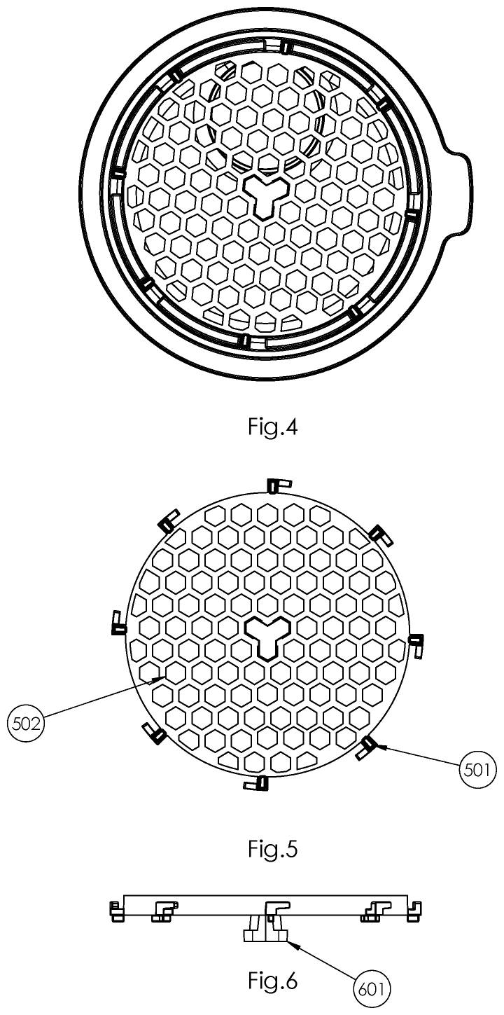

1. A lid for use with a beverage container, the lid comprising:
a cover, wherein the cover has a drink aperture formed therewithin;
a sidewall configured to sealingly engage a beverage container; and
a filter that is disposed within the sidewall and is configured to allow liquid within a beverage container to flow therethrough toward the cover while blocking solid particles from doing the same.

2. The lid of claim 1, further comprising a drink cover configured to cover said drink aperture and thereby block liquid from flowing therethrough, wherein the drink cover is mounted to said lid cover such that it is pivotable between a range of open positions and a closed position in which it covers said drink aperture.

3. The lid of claim 1, wherein said filter is defined by a sheet with a plurality of filter apertures formed within it, wherein these filter apertures are dimensioned to breakup clumps of solid matter as they attempt to travel therethrough.

4. The lid of claim 3, wherein said filter further comprises a pull tab disposed at its center and extending downward, wherein the pull tab is for gripping to move said filter relative to said sidewall.

5. The lid of claim 1, wherein said sidewall is configured to friction-fit against the inner surface of a beverage container.

6. The lid of claim 1, wherein said sidewall is configured to threadingly engage the inner surface of a beverage container.

7. A lid for use with a beverage container, the lid comprising:
a cover, wherein the cover has a drink aperture formed therewithin;
a sidewall configured to sealingly engage a beverage container, wherein grooves are formed within its lower rim; and
a filter configured to allow liquid within a beverage container to flow therethrough toward the cover while blocking solid particles from doing the same, wherein tabs are formed along the perimeter of the filter and are configured to lodge within the sidewall grooves such the filter secures to the sidewall.

8. The lid of claim 7, further comprising a drink cover configured to cover said drink aperture and thereby block liquid from flowing therethrough, wherein the drink cover is mounted to said lid cover such that it is pivotable between a range of open positions and a closed position in which it covers said drink aperture.

9. The lid of claim 7, wherein said filter is defined by a sheet with a plurality of filter apertures formed within it, wherein these filter apertures are dimensioned to breakup clumps of solid matter as they attempt to travel therethrough.

10. The lid of claim 9, wherein said filter further comprises a pull tab disposed at its center and extending downward, wherein the pull tab is for gripping to move said filter relative to said sidewall.

11. The lid of claim 7, wherein said sidewall is configured to friction-fit against the inner surface of a beverage container.

12. The lid of claim 7, wherein said sidewall is configured to threadingly engage the inner surface of a beverage container.

13. A lid for use with a beverage container, the lid comprising:
a cover, wherein the cover has a drink aperture formed therewithin;
a sidewall configured to sealingly engage a beverage container, wherein grooves are formed within its lower rim; and
a filter configured to allow liquid within a beverage container to flow therethrough toward the cover while blocking solid particles from doing the same, wherein the filter is configured to snap fit within the sidewall.
such the filter secures to the sidewall.

14. The lid of claim 13, further comprising a drink cover configured to cover said drink aperture and thereby block liquid from flowing therethrough, wherein the drink cover is mounted to said lid cover such that it is pivotable between a range of open positions and a closed position in which it covers said drink aperture.

15. The lid of claim 13, wherein said filter is defined by a sheet with a plurality of filter apertures formed within it, wherein these filter apertures are dimensioned to breakup clumps of solid matter as they attempt to travel therethrough.

16. The lid of claim 15, wherein said filter further comprises a pull tab disposed at its center and extending downward, wherein the pull tab is for gripping to move said filter relative to said sidewall.

17. The lid of claim 13, wherein said sidewall is configured to friction-fit against the inner surface of a beverage container.

18. The lid of claim 13, wherein said sidewall is configured to threadingly engage the inner surface of a beverage container.
